(19) United States
(12) Patent Application Publication
(10) Pub. No.: US 2021/0148022 A1
(43) Pub. Date: May 20, 2021

(54) BIODEGRADABLE LAYERED COMPOSITE

(71) Applicant: 3M INNOVATIVE PROPERTIES COMPANY, St. Paul, MN (US)

(72) Inventors: Ignatius A. Kadoma, Cottage Grove, MN (US); Jeffrey A. Chambers, St. Paul, MN (US); Michael D. Romano, Circle Pines, MN (US); Mark Litwinow, Oakdale, MN (US); Olaf C. Moberg, New Brighton, MN (US)

(21) Appl. No.: 17/048,353

(22) PCT Filed: Mar. 19, 2019
(86) PCT No.: PCT/IB2019/052220

§ 371 Date: Oct. 16, 2020

Related U.S. Application Data
(60) Provisional application No. 62/659,851, filed on Apr. 19, 2018.

(51) Int. Cl. D04H 1/407; D04H 1/56; D04H 1/724; B32B 5/26; B32B 5/02; D04H 3/16

(52) U.S. Cl. CPC D04H 1/407; D04H 1/56; D04H 1/724; B32B 5/26; B32B 2264/108; D04H 3/16; B32B 2307/7163; D10B 2401/12; B32B 5/022

(57) ABSTRACT

Biodegradable layered composite comprising a first nonwoven biodegradable layer having a first and second major surface, the first nonwoven biodegradable layer comprising biodegradable polymeric melt-blown fibers, and a plurality of activated carbon particles enmeshed in the biodegradable polymeric melt-blown fibers. Biodegradable layered composite described herein can be used, for example, as a porous capture media for suspended nutrients in agricultural drainage.

### CROSS REFERENCE TO RELATED APPLICATION

This application claims the benefit of U.S. Provisional Patent Application No. 62/659,851, filed Apr. 19, 2018, the disclosure of which is incorporated by reference herein in its entirety.

### BACKGROUND

Film such as polyethylene films are commonly used in agricultural applications such as vegetable production to control weed growth and moisture. Concerns over disposal of petroleum-based plastics, however, have some growers seeking sustainable alternatives. Bioplastic films and spunbond, nonwoven biofabrics have shown potential as mulches in vegetable production field trials (see, e.g., Scientia Horticulturae, 193, 209-217 (2015) and HortTechnology, 26 (2), 148-155, April 2016). Unfortunately, these biomulches can be relatively expensive.

### SUMMARY

In view of the foregoing, we recognize there is a need in the art for less expensive bio-based alternatives for controlling weed growth and moisture.

In one aspect, the present disclosure describes a biodegradable layered composite comprising:

a first nonwoven biodegradable layer having a first and second major surface, the first nonwoven biodegradable layer comprising:
biodegradable polymeric melt-blown fibers, and
a plurality of activated carbon particles enmeshed in the biodegradable polymeric melt-blown fibers. Optionally the degradable layered composite further comprises a second nonwoven biodegradable layer having first and second major surface. Optional second nonwoven biodegradable layer comprises spunbond fibers on first major surface of the first nonwoven biodegradable layer. Optionally, the degradable layered composite further comprises a third nonwoven biodegradable layer having first and second major surface. Optional third nonwoven biodegradable layer comprises spunbond fibers on second major surface of first nonwoven biodegradable layer.

As used herein, “biodegradable layered composites” refer to layered composites made primarily (i.e., at least 50 percent by weight, based on the total weight of the biodegradable layered composite), from a renewable plant source.

As used herein, “biodegradable” refers to materials or products that meet the requirements of ASTM D6400-12 (2012), which is the standard used to establish whether materials or products satisfy the requirements for labeling as “compostable in municipal and industrial composting facilities.”

As used herein, “enmeshed” refers to particles that are dispersed and physically held in the fibers of a nonwoven biodegradable layer.

As used herein, “melt-blown” refers to making fine fibers by extruding a thermoplastic polymer through a die having at least one hole. As the fibers emerge from the die, they are attenuated by an air stream.

As used herein, “particles” refer to a small piece or individual part. The particles used in embodiments of biodegradable layered composite described herein can remain separate or may be clumped, physically intermesh, electro-statically associated, or otherwise associated to form particulates.

Biodegradable layered composites described herein can be used, for example, as biomulch for controlling weed growth and moisture. The biodegradability of the biodegradable layered composite addresses concerns about the environmental impact associated with polyethylene film mulch removal and disposal. In addition, crop growers can reduce the time and labor associated with removal and disposal. The inclusion of particles in the biodegradable layered composite reduces the overall cost of biofabric-type materials. In some embodiments, the particles can provide additional benefits such as additional moisture retention, enrichment of the soil, and fertilization. In some embodiments, the particles can increase the overall rate of biodegradation of the biodegradable layered composite.

Agricultural drainage is an important contributing factor to high crop productivity in much of, for example, the Midwest of United States of America. Modern crop production would not be possible in many parts of this region without artificial subsurface drainage. Drainage, however, is associated with an increase in nitrate loads to streams, rivers, and the Gulf of Mexico, where it may contribute to the low oxygen or hypoxic zone (Christianson, L. E., et al., Pub. C1400, University of Illinois Extension, 2016). As such, there is great interest in reducing nitrate loads from drained land. In addition, there is interest in a mechanism to return the sequestered nitrates back to the field where they can be reused as fertilizer.

In this disclosure, the biodegradable layered composite, loaded with activated carbon particles, may be inserted in drain pipes to act as a porous capture media that absorbs suspended nutrients while letting water drain through. When saturated with nutrients, the capture media can be dumped and tilled into the soil, where it releases the nutrients and activated carbon as it biodegrades.

### BRIEF DESCRIPTION OF THE DRAWING

FIG. is a cross-sectional view of an exemplary biodegradable layered composite described herein.

### DETAILED DESCRIPTION

Referring to the FIG., exemplary biodegradable layered composite 100 comprises first nonwoven biodegradable layer 101 having a first and second major surface 111, 112 and plurality of activated carbon particles 115. First nonwoven biodegradable layer 101 comprises biodegradable polymeric melt-blown fibers 102. Plurality of activated carbon particles 115 are enmeshed in biodegradable polymeric melt-blown fibers 102. Optionally degradable layered composite 100 further comprises second nonwoven biodegradable layer 131 having first and second major surface 132, 133. Optional second nonwoven biodegradable layer 131 comprises spunbond fibers 135 on first major surface 111 of first nonwoven biodegradable layer 101. Optionally degradable layered composite 100 further comprises third nonwoven biodegradable layer 141 having first and second major surface 142, 143. Optional third nonwoven biodegradable layer 141 comprises spunbond fibers 145 on second major surface 112 of first nonwoven biodegradable layer 101.

Exemplary activated carbon particles are available, for example, under the trade designations “PGW 20MP”, “PGW-100MP”, “PGW-20MD”, “PGW-100MD”, “PGW-120MP”, “PGWH-160MP”, “PGWH-80X150”, “PGW-150MP”, “PGWH-200MP”, “PGWH-200MP”, “PKC 50MP”, “COCONUT SHELL CARBON”, and “GW-HK 12X30” from Kuraray, Tokyo, Japan; “3164-PP” and “CARBON 3164-325XF” from Calgon Carbon Corporation, Moon Township, Pa.; “CR8325C-WW/70” and “OXPURE 2050C-60” from Oxbow Activated Carbon, West Palm Beach, Fla.; “NUCHAR AQUAGUARD 80×325” and “NUCHAR AQUAGUARD” from Ingevity Corporation, Covington, Va.; “CARBON-COCONUT CP2” from Carbon Resources, Oceanside, Calif.; “ALCARBON CI 55” from Donau Carbon, Frankfurt, Germany; and “AQUASORB NP1”, “AQUASORB LS 0.5”, “AQUASORB NZ”, “AQUASORB CR 80×325”, “AQUASORB LX 0.5 20×50”, “AQUASORB LT-F-0.5, 80×325”, “COCONUT SHELL CARBON FINE”, “CARBON-COCONUT CP3 GX203”, “CARBON GA PLUS 80X325” and “AQUASORB LS 0.5, 60×140” from Jacobi Carbons, Kalmar, Sweden.

In some embodiments, the activated carbon can be surface-modified to target or capture specific chemicals in agricultural drainage (see, e.g., U.S. Pat. Pub. No. US2014319061 (Doyle et al.)). Techniques for surface modifying activated carbon are known in the art. In some embodiments, at least 10 (in some embodiments, at least 20, 25, 30, 40, 50, 60, 70, 75, 80, 90, 95, or even 100) percent by weight of the activated carbon particles are surface-modified.

In some embodiments, a first nonwoven biodegradable layer comprises at least 10 (in some embodiments, at least 20, 25, 30, 40, 50, 60, 70, 75, 80, or even at least 90; in some embodiments, in a range from 10 to 90, 20 to 90, 25 to 90, 30 to 90, 40 to 90, 50 to 90, or even 60 to 90) percent by weight of the activated carbon particles, based on the total weight of the nonwoven biodegradable layer.

In some embodiments, the activated carbon particles have an average particle size in a range from 1 to 2000 (in some embodiments, in a range from 1 to 1000, 1 to 500, 1 to 100, 1 to 75, 1 to 50, 1 to 25, or even 1 to 10) micrometers.

In some embodiments, the activated carbon particles are in a range from 10 US mesh to 12000 US mesh (in some embodiments, in a range from 200 US mesh to 400 US mesh).

Optionally, at least one nonwoven biodegradable layer comprises filler particles. Exemplary filler particles include agricultural and forestry waste such as rice hulls, wood fiber, starch flakes, bug flour, soy meal, alfalfa meal and biochar, or minerals such as gypsum and calcium carbonate. In some embodiments, the particles are biodegradable. In some embodiments, the particles contain nitrogen. Examples of useful nitrogen-containing materials include composted turkey waste, feather meal, and fish meal. In some embodiments, the particles are inorganic particles. For example, the particles can comprise fertilizers, lime, sand, clay, vermiculite or other related soil conditioners and pH modifiers. In some embodiments, the particles comprise a material that provides improved moisture retention and/or accelerates biodegradation of the biofabric and/or provides improved soil fertility.

In some embodiments, the filler particles have an average particle size in a range from 1 to 2000 (in some embodiments, in a range from 1 to 1000, 1 to 500, 1 to 100, 1 to 75, 1 to 50, 1 to 25, or even 1 to 10) micrometers.

In some embodiments, collectively the filler and activated carbon particles are present in the biodegradable layered composite in a range from 1 to 85 (in some embodiments, in a range from 10 to 80, 25 to 80, or even 50 to 60) percent by weight, based on the total weight of the of the biodegradable layered composite 25 to 75.

In some embodiments, at least 50 (in some embodiments, at least 60, 70, 75, 80, 85, 90, 95, 99, or even at least 100) percent by weight, based on the total weight of filler particles, of the filler particles comprise (in some embodiments, comprise at least 50, 60, 70, 75, 80, 85, 90, 95, 99 or even at least 100 percent by weight, based on the total weight of the respective filler particle) at least one of agricultural waste or forestry waste. In some embodiments, at least 50 (in some embodiments, at least 60, 70, 75, 80, 85, 90, 95, 99, or even at least 100) percent by weight, based on the total weight of particles, of the filler particles comprise (in some embodiments, comprise at least 50, 60, 70, 75, 80, 85, 90, 95, 99 or even at least 100 percent by weight, based on the total weight of the respective filler particle) inorganic material. In some embodiments, at least 50 (in some embodiments, at least 60, 70, 75, 80, 85, 90, 95, 99, or even at least 100) percent by weight, based on the total weight of filler particles, comprise (in some embodiments, comprise at least 50, 60, 70, 75, 80, 85, 90, 95, 99 or even at least 100 percent by weight, based on the total weight of the respective filler particle) at least one of turkey waste, feather meal, or fish meal. In some embodiments, at least 50 (in some embodiments, at least 60, 70, 75, 80, 85, 90, 95, 99, or even 100) percent by weight, based on the total weight of particles, of the filler particles contain nitrogen.

In some embodiments, the filler particles are in a range from 10 US mesh to 12000 US mesh (in some embodiments, in a range from 25 US mesh to 35 US mesh). In some embodiments, the filler particles are as small as 80 US mesh and as large as 5 US mesh.

The polymeric melt-blown fibers comprise biodegradable materials. In some embodiments, the biodegradable melt-blown fibers comprise at least one of polylactic acid (PLA), polybutylene succinate (PBS), naturally occurring zein, polycaprolactone, cellulosic ester, polyhydroxyalkanoate (PHA) (e.g., poly-3-hydroxybutyrate (PHB), polyhydroxyvalerate (PHV), or polyhydroxyhexanoate (PHH)).

In some embodiments, the biodegradable polymeric melt-blown fibers have an average fiber diameter in a range from 1 to 50 (in some embodiments, in a range from 1 to 40, 1 to 30, 1 to 20, 1 to 15, or even 1 to 10) micrometers. In some embodiments, the average diameter of the particles is larger than the average diameter of the fibers for particle capture. In some embodiments, the ratio of average particle diameter to average fiber diameter is a range from 160:1 to 5:1 (in some embodiments, in a range from 150:1 to 5:1, 125:1 to 5:1, 100:1 to 5:1, 75:1 to 5:1, 50:1 to 5:1, 25:1 to 5:1, or even 15:1 to 5:1).

The nonwoven biodegradable layers can be made by techniques known in the art. For example, the nonwoven biodegradable layer can be formed by methods comprising flowing molten polymer through a plurality of orifices to form filaments; attenuating the filaments into fibers; directing a stream of particles amidst the filaments or fibers; and collecting the fibers and particles as a nonwoven layer. Further, for example, the nonwoven biodegradable layers may be formed by adding particles, particulates, and/or agglomerates or blends of the same, if applicable, to an air stream that attenuates polymeric melt-blown fibers and conveys these fibers to a collector. The particles become enmeshed in a melt-blown fibrous matrix as the fibers contact the particles in the mixed air stream and are collected to form a layer. Similar processes for forming particle-loaded webs (layers) are described, for example, in U.S. Pat. No. 7,828,969 (Eaton et al.), the disclosure of which is hereby incorporated by reference. Relatively high particle loadings (e.g., up to 97% by weight) are possible according to such methods.

In some embodiments, nonwoven biodegradable layers have an average thickness in a range from 10 to 3000 (in some embodiments, in a range from 10 to 2000, 10 to 1000, 10 to 500, 10 to 100, or even 10 to 50) micrometers.

In some embodiments, biodegradable layered composites described herein have a basis weight in a range from 60 g/m² to 300 g/m². The biodegradable layered composite needs to be sufficiently heavy for acting as a weed barrier but is preferably not too heavy for handling by farm workers or machinery.

In some embodiments, the biodegradable polymeric fibers comprise bi-component fibers comprising a core material covered with a sheath wherein the sheath material (with a lower melting point) melts to bind with other fibers but the core material (with a higher melting point) maintains its shape. In other embodiments, the biodegradable polymeric melt-blown fibers have a homogenous structure. The homogenous structure may consist of one material or a plurality of materials evenly distributed or dispersed within the structure.

The particle loading process is an additional processing step to a standard melt-blown fiber forming process, as disclosed in, for example, U.S. Pat. Pub. No. 2006/0096911 (Brey et al.), the disclosure of which is incorporated herein by reference. Blown microfibers (BMF) are created by a molten polymer entering and flowing through a die, the flow being distributed across the width of the die in the die cavity and the polymer exiting the die through a series of orifices as filaments. In one exemplary embodiment, a heated air stream passes through air manifolds and an air knife assembly adjacent to the series of polymer orifices that form the die exit (tip). This heated air stream can be adjusted for both temperature and velocity to attenuate (draw) the polymer filaments down to the desired fiber diameter. The BMF fibers are conveyed in this turbulent air stream towards a rotating surface where they collect to form a layer.

Desired particles are loaded into a particle hopper where they gravimetrically fill recessed cavities in a feed roll. A rigid or semi-rigid doctor blade, with segmented adjustment zones, forms a controlled gap against the feed roll to restrict the flow out of the hopper. The doctor blade is normally adjusted to contact the surface of the feed roll to limit particulate flow to the volume that resides in the recesses of the feed roll. The feed rate can then be controlled by adjusting the speed that the feed roll turns. A brush roll operates behind the feed roll to remove any residual particulates from the recessed cavities. The particulates fall into a chamber that can be pressurized with compressed air or other sources of pressured gas. This chamber is designed to create an air stream that will convey the particles and cause the particles to mix with the melt-blown fibers being attenuated and conveyed by the air stream exiting the melt-blown die.

By adjusting the pressure in the forced air particulate stream, the velocity distribution of the particles is changed. When very low particle velocity is used, the particles may be diverted by the die air stream and not mix with the fibers. At low particle velocities, the particles may be captured only on the top surface of the layer. As the particle velocity increases, the particles begin to more thoroughly mix with the fibers in the melt-blown air stream and can form a uniform distribution in the collected layer. As the particle velocity continues to increase, the particles partially pass through the melt-blown air stream and are captured in the lower portion of the collected layer. At even higher particle velocities, the particles can totally pass through the melt-blown air stream without being captured in the collected layer.

In some embodiments, the particles are sandwiched between two filament air streams by using two generally vertical, obliquely-disposed dies that project generally opposing streams of filaments toward the collector. Meanwhile, particles pass through the hopper and into a first chute. The particles are gravity fed into the stream of filaments. The mixture of particles and fibers lands against the collector and forms a self-supporting particle-loaded nonwoven layer.

In other exemplary embodiments, the particles are provided using a vibratory feeder, an eductor, or other techniques known to those skilled in the art.

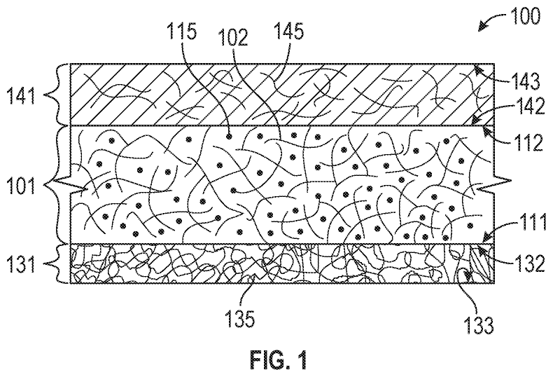

Spunbond fibers are known in the art and refer to fabrics that are produced by depositing extruded, spun filaments onto a collecting belt in a uniform random manner followed by bonding the fibers. The fibers are separated during the layering process by air jets or electrostatic charges. Layers comprising spunbond fibers can be provided by techniques known in the art (e.g., using an apparatus generally as shown in FIG. 1 of U.S. Pat. No. 8,802,002 (Berrigan et al.), the disclosure of which is incorporated herein by reference) and are also commercially available, for example, under the trade designation “INGEO BIOPOLYMER 6202D” (polylactic acid fibers; spunbond scrim, smooth calendar) from NatureWorks LLC, Minnetonka, Minn. Using techniques known in the art, the melt-blown fibers, for example, can be blown onto a spunbonded web, and the resulting articles passed through two calendar rolls.

For many agricultural applications, substantially uniform distribution of particles throughout the nonwoven biodegradable layer may be advantageous so that as particles are added evenly to the soil, they compost and enrich it. Gradients through the depth or length of the nonwoven biodegradable layer are possible, however, if desired.

### EXEMPLARY EMBODIMENTS

1. A biodegradable layered composite comprising:

a first nonwoven biodegradable layer having a first and second major surface, the first nonwoven biodegradable layer comprising:
biodegradable polymeric melt-blown fibers, and
a plurality of activated carbon particles enmeshed in the biodegradable polymeric melt-blown fibers.
   2. The biodegradable layered composite of Exemplary Embodiment 1, wherein melt-blown fibers comprise at least one of polylactide (PLA), polybutylene succinate (PBS) naturally occurring zein, polycaprolactone, cellulosic ester, polyhydroxyalkanoate (PHA) (e.g., poly-3-hydroxybutyrate (PHB), polyhydroxyvalerate (PHV), or polyhydroxyhexanoate (PHH)).
   3. The biodegradable layered composite of any preceding Exemplary Embodiment, wherein the first nonwoven biodegradable layer comprises at least 10 (in some embodiments, at least 20, 25, 30, 40, 50, 60, 70, 75, 80, or even at least 90; in some embodiments, in a range from 10 to 90, 20 to 90, 25 to 90, 30 to 90, 40 to 90, 50 to 90, or even 60 to 90) percent by weight of the activated carbon particles, based on the total weight of the first nonwoven biodegradable layer.
   4. The biodegradable layered composite of any preceding Exemplary Embodiment, wherein the activated carbon particles have an average particle size in a range from 1 to 2000 (in some embodiments, in a range from 1 to 1000, 1 to 500, 1 to 100, 1 to 75, 1 to 50, 1 to 25, or even 1 to 10) micrometers.
   5. The biodegradable layered composite of any preceding Exemplary Embodiment, wherein the activated carbon particles are in a range from 10 US mesh to 12000 US mesh (in some embodiments, in a range from 200 US mesh to 400 US mesh).
   6. The biodegradable layered composite of any preceding Exemplary Embodiment, wherein the biodegradable polymeric melt-blown fibers have an average fiber diameter in a range from 1 to 50 (in some embodiments, in a range from 1 to 40, 1 to 30, 1 to 20, 1 to 15, or even 1 to 10) micrometers.
   7. The biodegradable layered composite of any preceding Exemplary Embodiment, wherein the ratio of average activated carbon particle diameter to average melt-blown fiber diameter is in a range from 160:1 to 5:1 (in some embodiments, in a range from 150:1 to 5:1, 125:1 to 5:1, 100:1 to 5:1, 75:1 to 5:1, 50:1 to 5:1, 25:1 to 5:1, or even 15:1 to 5:1).
   8. The biodegradable layered composite of any preceding Exemplary Embodiment, wherein first nonwoven biodegradable layer further comprises at least one of agricultural waste or forestry waste (e.g., particles that are at least one of rice hulls, wood flour, starch flakes, bug flour, soy meal, alfalfa meal, or biochar).
   9. The biodegradable layered composite of any preceding Exemplary Embodiment, wherein first nonwoven biodegradable layer further comprises inorganic material (e.g., particles comprise at least one of lime, gypsum, sand, clay, or vermiculite).
   10. The biodegradable layered composite of any preceding Exemplary Embodiment, wherein first nonwoven biodegradable layer further comprises at least one of turkey waste, feather meal, or fish meal.
   11. The biodegradable layered composite of any preceding Exemplary Embodiment further comprising a second nonwoven biodegradable layer comprising first spunbond fibers on the first major surface of the first nonwoven biodegradable layer.
   12. The biodegradable layered composite of Exemplary Embodiment 11, wherein the first spunbond fibers comprise at least one of polylactide (PLA), polybutylene succinate (PBS) naturally occurring zein, polycaprolactone, cellulosic ester, polyhydroxyalkanoate (PHA) (e.g., poly-3-hydroxybutyrate (PHB), polyhydroxyvalerate (PHV), or polyhydroxyhexanoate (PHH)).
   13. The biodegradable layered composite of either Exemplary Embodiment 11 or 12, wherein the first spunbond fibers have an average fiber diameter in a range from 10 to 50 (in some embodiments, in a range from 10 to 40, 10 to 30, 10 to 25, 10 to 20, or even 10 to 15) micrometers.
   14. The biodegradable layered composite of any of Exemplary Embodiments 11 to 13, wherein the second nonwoven biodegradable layer has an average thickness in a range from 10 to 3000 (in some embodiments, in a range from 10 to 2000, 10 to 1000, 10 to 500, 10 to 100, or even 10 to 50) micrometers.
   15. The biodegradable layered composite of any of Exemplary Embodiments 11 to 14 further comprising a third nonwoven biodegradable layer comprising second spunbond fibers on the second major surface of the first nonwoven biodegradable layer.
   16. The biodegradable layered composite of Exemplary Embodiment 15, wherein the second spunbond fibers comprise at least one of polylactide (PLA), polybutylene succinate (PBS) naturally occurring zein, polycaprolactone, cellulosic ester, polyhydroxyalkanoate (PHA) (e.g., poly-3-hydroxybutyrate (PHB), polyhydroxyvalerate (PHV), or polyhydroxyhexanoate (PHH)).
   17. The biodegradable layered composite of either Exemplary Embodiment 15 or 16, wherein the second spunbond fibers have an average fiber diameter in a range from 10 to 50 (in some embodiments, in a range from 10 to 40, 10 to 30, 10 to 25, 10 to 20, or even 10 to 15) micrometers.
   18. The biodegradable layered composite of any of Exemplary Embodiments 15 to 17, wherein the third nonwoven biodegradable layer has an average thickness in a range from 10 to 3000 (in some embodiments, in a range from 10 to 2000, 10 to 1000, 10 to 500, 10 to 100, or even 10 to 50) micrometers.
   19. The biodegradable layered composite of any preceding Exemplary Embodiment having a basis weight in a range from 60 g/m² to 300 g/m².
   20. The biodegradable layered composite of any preceding Exemplary Embodiment, wherein the melt-blown fibers comprise carbon black.
   21. The biodegradable layered composite of any preceding Exemplary Embodiment, wherein the first nonwoven biodegradable layer has an average thickness in a range from 10 to 3000 (in some embodiments, in a range from 10 to 2000, 10 to 1000, 10 to 500, 10 to 100, or even 10 to 50) micrometers.
   22. The biodegradable layered composite of any preceding Exemplary Embodiment, wherein at least some of the activated carbon particles are surface-modified. In some embodiments, at least 10 (in some embodiments, at least 20, 25, 30, 40, 50, 60, 70, 75, 80, 90, 95, or even 100) percent by weight of the activated carbon particles are surface-modified.
   23. The biodegradable layered composite of any preceding Exemplary Embodiment provided as a roll.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. The Table, below lists materials used in the examples and their sources.

TABLE

| Designation | Description | Source |
|---|---|---|
| PLA1 | Polylactic acid, obtained under the trade | NatureWorks, LLC, |
| | designation “INGEO BIOPOLYMER 6252D” | Minnetonka, MN |
| PLA2 | Polylactic acid, obtained under the trade | NatureWorks, LLC |
| | designation “INGEO BIOPOLYMER 4032D” | |
| Carbon black | Carbon black pigment | Clariant Corporation, |
| | | Minneapolis, MN |
| Wood | Wood, 40 mesh, obtained under the trade | American Wood |
| | designation “AWF MAPLE 4010” | Fibers, Schofield, WI |
| Rice hulls | Unground rice hulls, used as supplied | Riceland Foods, Inc., |
| | | Stuttgart, AR |
| Activated Carbon | Coconut Shell Carbon | Kuraray, Tokyo, |
| | | Japan |
| PLA3 | Polylactic acid, obtained under the trade | NatureWorks, LLC |
| | designation “INGEO BIOPOLYMER 6202D” | |
| Calcium Carbonate | Calcium Carbonate | Sigma-Aldrich |
| | | Company, St. Louis, |
| | | MO |

### Comparative Example

The Comparative Example comprises a 30-g/m² spunbond fabric of PLA3 “INGEO BIOPOLYMER 6202D”. The fabric was made using an apparatus as shown in FIG. 1 of U.S. Pat. No. 8,802,002 (Berrigan et al.), the disclosure of which is incorporated herein by reference. The resulting article had a basis weight, g/m², of Film/BMF/particle/scrim/total of 0/0/30/30 g/m².

### Example

The biodegradable layered composite Example was prepared as follows. Biodegradable polylactic acid resin PLA1 (“INGEO BIOPOLYMER 6252D”) was melt-blown using an apparatus as shown in FIG. 6 of U.S. Pat. Pub. No. 2006/0096911 (Brey et al.), the disclosure of which is incorporated herein by reference. The activated carbon particles (obtained under the trade designation “OM93642451” from Clariant, Minneapolis, Minn.) were dropped directly onto the molten fibers exiting the extruder die using a vibratory feeder (obtained under the trade designation “MECHATRON” from Schenck AccuRate, Fairfield, N.J.) attached to melt blowing equipment (as described, for example, in U.S. Pat. No. 7,828,969 (Eaton et al.), the disclosure of which is hereby incorporated by reference) causing the activated carbon particles to become captured and enmeshed in the molten polymer fibers. The resulting material was sprayed onto a 30-g/m² spunbond scrim of PLA3 (“INGEO BIOPOLYMER 6202D”). The scrim was manufactured as described in the Comparative Example. The combined roll of blown micro fiber (BMF)/particles cast onto a spunbond scrim was then passed between a pair of smooth calendar rolls to flatten and bond the composite fabric. The result is a biodegradable layered composite where the layers comprise, by basis weight, of: “BMF/particle/scrim/total”=“20/40/30/90 g/m².”

Test Methods

Suspended Particles Filtration Test

A pair of scissors was used to cut a rectangular piece of prepared biodegradable layered composite. The samples were cut to the following dimensions: 10 centimeters (cm)×12 cm. Each sample was water-conditioned for 6 hours by submerging the sample in 800 milliliters (mL) of water contained in a 946-mL bottle (obtained from Thermo Fisher Scientific Inc., Minneapolis, Minn.). After conditioning, each sample was then tightly secured to the open mouth of an empty 400 milliliter (mL) glass beaker (obtained from Thermo Fisher Scientific Inc.) using an elastic band, making sure that a 5-cm sag was created in the sample, at the mouth of the empty 400 mL glass beaker. The sag in the sample ensured the test liquid did not overflow as it drained through the biodegradable layered composite. Separately, a test liquid sample containing suspended solids in water was prepared as follows: 5 grams of calcium carbonate (obtained from Sigma-Aldrich Company) was added to 500 grams of water contained in a 946-mL bottle. A bottle cover was secured to the top of the bottle and the mixture contained therein was shaken by hand for 2-3 minutes, ensuring a uniform, turbid suspension was created. Less or more shaking time may be needed, depending on how vigorously the bottle is shaken. The suspension was then divided into two separate 200 mL of suspended solids in water, which were poured, respectively, through each biodegradable layered sample that had been secured to the open mouth of an empty 400 mL glass beaker, as described above.

The turbidity of the filtrate from each sample was qualitatively determined by visual appearance. The filtrate from the Example appeared to be less turbid than the Comparative Example.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A biodegradable layered composite comprising:
a first nonwoven biodegradable layer having a first and second major surface, the first nonwoven biodegradable layer comprising:
biodegradable polymeric melt-blown fibers, and
a plurality of activated carbon particles enmeshed in the biodegradable polymeric melt-blown fibers.

2. The biodegradable layered composite of claim 1, wherein melt-blown fibers comprise at least one of polylactide, polybutylene succinate, naturally occurring zein, polycaprolactone, or cellulosic ester, polyhydroxyalkanoate.

3. The biodegradable layered composite of claim 1, wherein the first nonwoven biodegradable layer comprises at least 10 percent by weight of the activated carbon particles, based on the total weight of the first nonwoven biodegradable layer.

4. The biodegradable layered composite of claim 1, wherein the activated carbon particles have an average particle size in a range from 1 to 2000 micrometers.

5. The biodegradable layered composite of claim 1, wherein the biodegradable polymeric melt-blown fibers have an average fiber diameter in a range from 1 to 50 micrometers.

6. The biodegradable layered composite of claim 1, wherein the ratio of average activated carbon particle diameter to average melt-blown fiber diameter is in a range from 160:1 to 5:1.

7. The biodegradable layered composite of claim 1 further comprising a second nonwoven biodegradable layer comprising first spunbond fibers on the first major surface of the first nonwoven biodegradable layer.

8. The biodegradable layered composite of claim 7 further comprising a third nonwoven biodegradable layer comprising second spunbond fibers on the second major surface of the first nonwoven biodegradable layer.

9. The biodegradable layered composite of claim 8, wherein the second spunbond fibers comprise at least one of polylactide, polybutylene succinate, naturally occurring zein, polycaprolactone, cellulosic ester, or polyhydroxyalkanoate.

10. The biodegradable layered composite of claim 7, wherein the third nonwoven biodegradable layer has an average thickness in a range from 10 to 3000 micrometers.

11. The biodegradable layered composite of claim 1 having a basis weight in a range from 60 g/m² to 300 g/m².

12. The biodegradable layered composite of claim 1, wherein the first nonwoven biodegradable layer has an average thickness in a range from 10 to 3000 micrometers.

13. The biodegradable layered composite of claim 1, wherein the at least some of the activated carbon particles are surface modified.

14. The biodegradable layered composite of claim 1, wherein at least 50 percent by weight of the activated carbon particles are surface-modified.

15. The biodegradable layered composite of claim 1 is provided as a roll.
